(19) United States
(12) Patent Application Publication
(10) Pub. No.: US 2026/0029994 A1
(43) Pub. Date: Jan. 29, 2026

(54) MULTI-SPACE PROGRAMMING METHOD FOR APPLICATION DEVELOPMENT

(71) Applicant: Guangzhou Yunbiaoju Network Technology Co., Ltd., Guangzhou (CN)

(72) Inventor: Yadong ZHANG, Guangzhou (CN)

(21) Appl. No.: 18/923,435

(22) Filed: Oct. 22, 2024

(30) Foreign Application Priority Data
Jul. 25, 2024 (CN) 2024110046096

(51) Int. Cl. G06F 8/34

(52) U.S. Cl. CPC G06F 8/34

(57) ABSTRACT

This application pertains to the field of computer technology and discloses a multi-space programming method for application development. The user inputs information in the graphical interface of Application A, located in the desktop space. This information is encapsulated as a vimcall message and transmitted to the terminal space through network transmission. The terminal space analyzes the vimcall message to determine whether backend processing is required. If backend processing is unnecessary, the vimcall message is handled by the frontend of Application A, or through collaboration between the frontend of Application A and the frontends of other applications, with the results displayed in the desktop space. If backend processing is required, the message is processed through backend invocation, and the results are transmitted back to the desktop space, where the application's interface displays the processed information. This method enables the invocation of both frontend and backend components within the desktop and terminal spaces to process the required system data, thereby simplifying and standardizing the interaction between applications and reducing the development complexity for developers.

### TECHNICAL FIELD

This application pertains to the field of computer technology, specifically to a multi-space programming method for application development.

### BACKGROUND

In traditional system application design and development, the relationship between the frontend and backend of applications is loosely coupled, which increases flexibility but complicates the interaction between multiple applications, raising the barrier for developers.

### SUMMARY

The objective of this application is to provide a multi-space programming method for application development, addressing the technical challenges outlined in the background.

To achieve this objective, the following technical solution is disclosed: a multi-space programming method for application development, comprising the following steps:
The user inputs information into the graphical interface of Application A, located in the desktop space;
The user's input is encapsulated into a vimcall message;
The vimcall message is transmitted to the terminal space through network transmission;
The terminal space analyzes the vimcall message to determine whether backend processing is required;
If backend processing is not required, the vimcall message is processed by the frontend of Application A or in collaboration with the frontends of other applications, and the results are displayed in the desktop space;
If backend processing is required, the vimcall message is processed through backend invocation, and the results are transmitted back to the desktop space and displayed on the application's interface. The backend invocation may involve: the backend of Application A, the frontend and backend of Application A, the backend of Application A and other applications, or the frontend and backend of Application A in conjunction with the frontends and/or backends of other applications.

Preferably, the desktop space and terminal space communicate through a WebSocket channel.

Preferably, in the backend invocation, after the frontend or backend of an application completes the processing of the vimcall message, the terminal space further analyzes whether additional processing is required. If further processing is needed, the vimcall message is handled by another application until the message is fully processed.

Preferably, the terminal space is equipped with artificial intelligence algorithms for processing and analyzing the vimcall message.

Preferably, these artificial intelligence algorithms are integrated into the terminal space through an AI interface.

Preferably, the API of the desktop space is configured to facilitate calls from the application layer and between application layers.

Preferably, the invocation within the terminal space utilizes a system-level channel, with the output of one application serving as the input for the next.

Preferably, in the backend invocation, the interaction between two applications involves the frontend of Application A calling the frontend of Application B, and the backend of Application A calling the backend of Application B.

### Beneficial Effects

The multi-space programming method for application development described in this application enables the invocation of both frontend and backend components within the desktop and terminal spaces to process the necessary system data. This approach simplifies and standardizes the interaction between applications, thereby reducing the complexity of development for developers.

### FIGURES WITH BRIEF DESCRIPTIONS

To provide a clearer explanation of the embodiments of this application or the technical solutions in the prior art, a brief introduction to the accompanying drawings used in the description of these embodiments or prior art is given below. It is evident that the drawings described below are merely some embodiments of this application. For those skilled in the art, other drawings may also be derived based on these drawings without inventive effort.

FIG. 1 is a flowchart illustrating the multi-space programming method for application development provided by an embodiment of this application.

FIG. 2 is a system block diagram corresponding to the multi-space programming method for application development provided by an embodiment of this application.

### DETAILED EMBODIMENTS

The technical solutions of the embodiments of this application will be clearly and comprehensively described below. It is evident that the described embodiments are only a portion of the embodiments of this application and not all of them. Based on these embodiments, all other embodiments that can be obtained by those skilled in the art without creative efforts are within the scope of this application.

In this context, the term “comprises” is intended to cover a non-exclusive inclusion, so that a process, method, article, or device that comprises a list of elements not only includes those elements but may also include other elements not expressly listed or inherent to such a process, method, article, or device. Without further limitation, elements defined by the phrase “comprises . . . ” do not exclude the existence of additional identical elements in the process, method, article, or device that includes those elements.

In application development and design, while the loose coupling between the frontend and backend of applications can increase flexibility, it also complicates the interaction between multiple applications, thereby raising the complexity for developers.

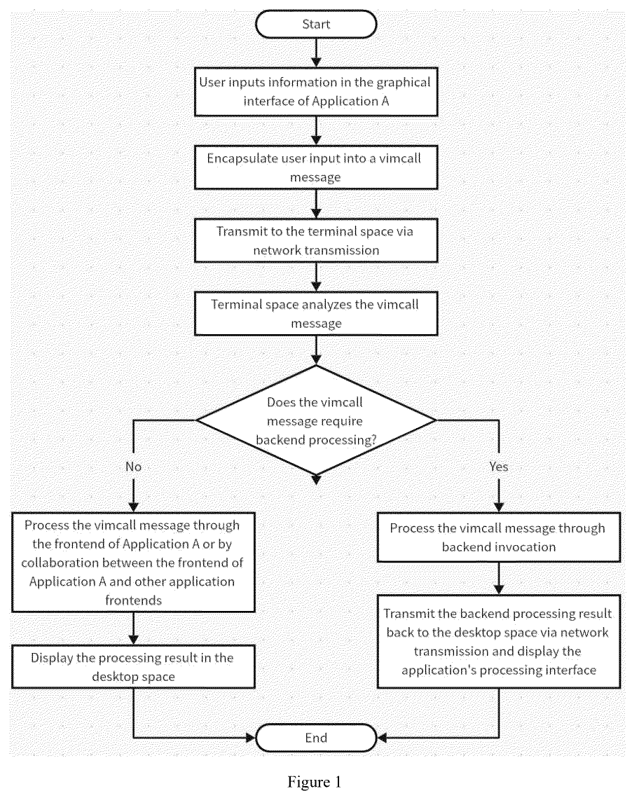

In response to this, the present embodiment discloses a multi-space programming method for application development, as shown in FIG. 1, aiming to simplify and standardize the interaction between the frontend and backend of applications. Specifically, the method comprises the following steps:
The user inputs information into the graphical interface of Application A, located in the desktop space;
The user's input is encapsulated into a vimcall message;
The vimcall message is transmitted to the terminal space through network transmission;
The terminal space analyzes the vimcall message to determine whether backend processing is required;
If backend processing is not required, the vimcall message is processed by the frontend of Application A or in collaboration with the frontends of other applications, and the results are displayed in the desktop space;
If backend processing is required, the vimcall message is processed through backend invocation, and the results are transmitted back to the desktop space and displayed on the application's interface. The backend invocation may involve: the backend of Application A, the frontend and backend of Application A, the backend of Application A and other applications, or the frontend and backend of Application A in conjunction with the frontends and/or backends of other applications.

In this embodiment, the terminal space is equipped with artificial intelligence algorithms designed to process and analyze the vimcall messages. These algorithms are integrated into the terminal space through an AI interface, which can be either a third-party AI interface or a proprietary AI platform interface. The application necessary for analyzing and processing the vimcall message is determined based on the specific data content of the vimcall message. The analysis identifies whether the frontend or backend of the corresponding application is required for processing. For those skilled in the art, any existing algorithm from current technologies may be employed.

In this method, the application layout is structured such that the frontend of the application runs in the desktop space, while the backend runs in the terminal space. To ensure stable communication between the desktop space and the terminal space, a WebSocket channel is utilized. The API of the desktop space is configured to support calls within the application layer and between different application layers. In the desktop space, the interaction between two applications is such that the frontend of Application A can call the frontend of Application B. The terminal space utilizes a system-level channel for communication, where the output of one application serves as the input for the next. Within the terminal space, the interaction between two applications is structured so that the backend of Application A can call the backend of Application B. However, between the desktop and terminal spaces, the frontend of Application A can only call its own backend and cannot call the backend of Application B. This design ensures that cross-calling between frontend and backend components is restricted to within the same application, thereby maintaining a strict separation of concerns.

As a preferred implementation of this embodiment, during the backend invocation process, once the frontend or backend of an application completes the processing of the vimcall message, the terminal space evaluates whether additional processing is necessary. If further processing is required, the vimcall message is handled by another application until the message has been fully processed.

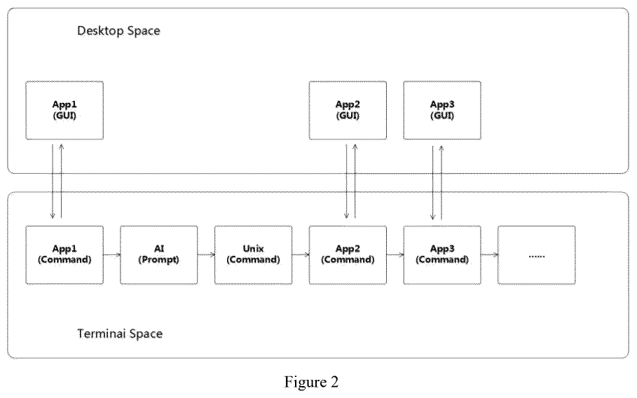

The following section provides a more detailed explanation of the multi-space programming method disclosed in this embodiment, using a specific operating system as an example. The chosen operating system is Codigger, where applications run with both frontend and backend components. The frontend operates within the Desktop Space, while the backend operates within the Terminai Space (terminal space), as illustrated in FIG. 2.

In the Desktop Space, the frontend is equipped with interfaces that allow for mutual invocation, similar to traditional operating systems where system-level APIs are available for applications running on the desktop. Codigger Desktop Space layer includes a Desktop API for application-level calls and also allows for API calls between different application levels. The APIs between applications in the Desktop Space must comply with the interface definition standards of the desktop space. In the Terminai Space, backend communication occurs through existing channels, allowing for mutual invocation between backends (the invocation in Terminai Space utilizes system-level channels, where the output of one application serves as the input for the next).

Based on the above structure, the process of handling a message is as follows:

The user's input is received through the frontend's graphical interface and is converted into system data, which is then transmitted through the network to the backend in the terminal space. The terminal space processes the user's information, often involving calls between multiple applications (data is transferred between applications using the system-level channels, enabling invocation within the Terminai Space). Applications in the Desktop Space include both frontend and backend code, each responsible for handling relevant information. The invocation between applications is designed such that the frontend of Application A can call the frontend of Application B, and similarly, the backend of Application A can call the backend of Application B. However, the frontend of Application A cannot call the backend of Application B, and vice versa. This means that applications within the same space can invoke each other, and within the same application, cross-space invocation is possible. This design concept expands the standards of application development, providing developers with a clear invocation logic while maintaining interoperability among multiple applications, thus reducing the complexity for developers.

In further detail, the specific invocation logic of this method is as follows:

1. The frontend of Application A calls its backend using a vimcall. For example:

[“share. WidgetManager”, “Initialise”, [“java-SpringBoot”, “/home/clouder/Downloads/sjava”, “0”, {“projectName”:“sjava”, “projectPath”:“/home/clouder/Downloads/sjava”, “package”:“oc.test”, “gitRepository”:“ ”, “codiggerSetting”:{“c odeStyle”:{“java”: [{“codeStyleName”:“ide”, “isDefault”:“1”, “indentsMode”:“useTab”, “tabSize”:4, “indent”:4}]}, “fileAndCodeTemplate”:{“java”:“ ”}}}]].

In this example, the backend service is named “share. WidgetManager”, the function name is “Initialise”, and the parameters for the function are enclosed in the square brackets.

2. The backend of Application A can invoke the backend interface of Application B using a pipeline method.

3. The frontend of Application A can invoke the frontend of Application B. For instance:

[“AppB”, “GetTitleColor”, [“parameters”]]

Here, “AppB” represents the name of Application B, “GetTitleColor” is the interface provided by the frontend of Application B, and [“parameters”] are the input parameters for the “GetTitleColor” interface.

In summary, the multi-space programming method provided in this embodiment facilitates the invocation of both frontend and backend components within the Desktop Space and Terminai Space. This approach simplifies and standardizes the invocation relationships between applications, thereby reducing the complexity for developers and making it easier to manage inter-application communication.

In the embodiments provided by this application, it should be understood that the described implementations can be realized through hardware, software, firmware, middleware, code, or any suitable combination thereof. For a hardware implementation, the processor may be embodied in one or more of the following units: Application-Specific Integrated Circuit (ASIC), Digital Signal Processor (DSP), Digital Signal Processing Device (DSPD), Programmable Logic Device (PLD), Field-Programmable Gate Array (FPGA), processor, controller, microcontroller, microprocessor, or other electronic units designed to execute the functions described herein, or any combination thereof.

For a software implementation, parts or all of the processes of the embodiments can be executed by instructing the relevant hardware through a computer program. The program can be stored in a computer-readable storage medium or transmitted as one or more instructions or codes on a computer-readable storage medium. A computer-readable storage medium includes both storage media and communication media, where communication media facilitate the transfer of computer programs from one location to another. Storage media can be any available media accessible by a computer. These can include, but are not limited to RAM, ROM, EEPROM, CD-ROM, or other optical disc storage, magnetic disk storage media, or other magnetic storage devices, or any other medium capable of carrying or storing the desired program code in the form of instructions or data structures and accessible by a computer.

Finally, it should be noted that the above descriptions are merely preferred embodiments of this application and are not intended to limit the scope of the application. Although this application has been described in detail with reference to the preceding embodiments, those skilled in the art may still make modifications to the technical solutions described in the aforementioned embodiments or perform equivalent replacements of some of the technical features. Any modifications, equivalent replacements, improvements, etc., made within the spirit and principles of this application shall fall within the scope of protection of this application.

What is claimed is:

1. A multi-space programming method for application development, characterized by the following steps:
The user inputs information into the graphical interface of Application A, located in the desktop space;
The user's input is encapsulated into a vimcall message;
The vimcall message is transmitted to the terminal space through network transmission;
The terminal space analyzes the vimcall message to determine whether backend processing is required;
If backend processing is not required, the vimcall message is processed by the frontend of Application A or in collaboration with the frontends of other applications, and the results are displayed in the desktop space;
If backend processing is required, the vimcall message is processed through backend invocation, and the results are transmitted back to the desktop space and displayed on the application's interface. The backend invocation may involve: the backend of Application A, the frontend and backend of Application A, the backend of Application A and other applications, or the frontend and backend of Application A in conjunction with the frontends and/or backends of other applications.

2. The multi-space programming method for application development according to claim 1, wherein communication between the desktop space and the terminal space is conducted through a WebSocket channel.

3. The multi-space programming method for application development according to claim 1, wherein in the backend invocation, after the frontend or backend of an application completes the processing of the vimcall message, the terminal space further analyzes whether additional processing is required. If further processing is needed, the vimcall message is processed by another application until the message is fully processed.

4. The multi-space programming method for application development according to claim 1, wherein the terminal space is equipped with artificial intelligence algorithms to process and analyze the vimcall message.

5. The multi-space programming method for application development according to claim 4, wherein the artificial intelligence algorithms are integrated into the terminal space through an AI interface.

6. The multi-space programming method for application development according to claim 4, wherein the API of the desktop space is configured to facilitate calls from the application layer and between application layers.

7. The multi-space programming method for application development according to claim 4, wherein the invocation within the terminal space utilizes a system-level channel, with the output of one application serving as the input for the next.

8. The multi-space programming method for application development according to claim 1, wherein the invocation between two applications in the backend involves the frontend of Application A calling the frontend of Application B, and the backend of Application A calling the backend of Application B.
